(19) United States
(12) Patent Application Publication
(10) Pub. No.: US 2014/0043855 A1
(43) Pub. Date: Feb. 13, 2014

(54) BACKLIGHT ASSEMBLY AND DISPLAY APPARATUS HAVING THE SAME

(71) Applicant: SAMSUNG DISPLAY CO., LTD., Yongin-City (KR)

(72) Inventors: Eui Jeong KANG, Asan-si (KR); Yu-Dong KIM, Suwon-si (KR); HYUK-HWAN KIM, Hwaseong-si (KR); SEKI PARK, Asan-si (KR); Si Joon SONG, Suwon-si (KR)

(73) Assignee: SAMSUNG DISPLAY CO., LTD., Yongin-City (KR)

(21) Appl. No.: 13/737,638

(22) Filed: Jan. 9, 2013

(30) Foreign Application Priority Data
Aug. 8, 2012 (KR) 10-2012-0086807

(51) Int. Cl. F21V 8/00; F21V 29/00

(52) U.S. Cl. CPC G02B 6/009; F21V 29/22
USPC 362/612

(57) ABSTRACT

A backlight assembly includes a receiving container, a light emitting unit and a light guide plate. The receiving container includes a bottom portion, and a sidewall extended from the bottom portion. The light emitting unit is on an inner lateral surface of the sidewall. The light guide plate is in the receiving container and includes a side surface facing the light emitting unit. The light emitting unit includes a light emitting diode package which generates light, a first lead frame and a second lead frame. The first lead frame is electrically connected to a first electrode of the light emitting diode package. The second lead frame is spaced apart from the first lead frame and electrically connected to a second electrode of the light emitting diode package.

This application claims priority to Korean Patent Application No. 10-2012-0086807, filed on Aug. 8, 2012, and all the benefits accruing therefrom under 35 U.S.C. §119, the contents of which are hereby incorporated by reference.

### BACKGROUND

1. Field

The invention relates to a backlight assembly, and a display apparatus having the backlight assembly. More particularly, the invention relates to a backlight assembly employing a light emitting diode package as a light source, and a display apparatus having the backlight assembly.

2. Description of the Related Art

To display an image, a liquid crystal display includes a backlight assembly in which light is generated. The backlight assembly includes a light source that generates the light in response to a source voltage from an external source. As the light source, a cold cathode fluorescent lamp (“CCFL”) or a light emitting diode (“LED”) package is widely used. Among these light sources, the CCFL has been replaced with the LED package since the LED package has advantages, such as low power consumption, high brightness, etc.

The LED package includes a light emitting diode as a point light source, and the LED package may be provided in a plural number in the backlight assembly. The plural LED packages may be mounted on a printed circuit board of the liquid crystal display, and electrically connected to the printed circuit board with wirings on the printed circuit board.

Accordingly, in order to electrically connect an LED package to the printed circuit board, a process of mounting the LED package on the printed circuit board is employed such that time and/or costs of manufacturing the backlight assembly is undesirably increased. In addition, the printed circuit board for the liquid crystal display may be replaced with a metal core printed circuit board (“MCPCB”). As a result, a manufacturing cost of the backlight assembly and the liquid crystal display is further undesirably increased.

### SUMMARY

One or more exemplary embodiment of the invention provides a backlight assembly capable of reducing a manufacturing cost thereof.

One or more exemplary embodiment of the invention provides a display apparatus having the backlight assembly.

One or more exemplary embodiment of the invention provides a backlight assembly including a receiving container, a light emitting unit and a light guide plate. The receiving container includes a bottom portion, and a sidewall extended from the bottom portion. The light emitting unit is on an inner lateral surface of the sidewall. The light guide plate is in the receiving container and includes a side surface facing the light emitting unit.

The light emitting unit includes a light emitting diode (“LED”) package which generates a light, a first lead frame and a second lead frame. The first lead frame is electrically connected to a first electrode of the LED package, and the second lead frame is spaced apart from the first lead frame and electrically connected to a second electrode of the LED package.

One or more exemplary embodiment of the invention provides a display apparatus including a display panel and a backlight assembly. The backlight assembly includes a receiving container, a light emitting unit and a light guide plate. The receiving container includes a bottom portion, and a sidewall extended from the bottom portion. The light emitting unit is on an inner lateral surface of the sidewall and generates a light. The display panel receives the light and displays an image. The light guide plate receives the light from the light emitting unit and guides the light to the display panel. The light guide plate is in the receiving container and includes a side surface facing the light emitting unit.

The light emitting unit includes an LED package which generates the light, a first lead frame and a second lead frame. The first lead frame is electrically connected to a first electrode of the LED package, and the second lead frame is spaced apart from the first lead frame and electrically connected to a second electrode of the LED package.

According to one or more exemplary embodiment of the invention, a plurality of LED packages may be electrically connected to each other by a plurality of lead frames instead of a conventional printed circuit board. Thus, the backlight assembly excludes the printed circuit board, so that a manufacturing cost of the backlight assembly may be reduced. In addition, when the plurality of lead frames is used to electrically connect the plurality of LED packages to each other, a process of mounting the plurality of LED packages on the printed circuit board, e.g., a surface mount technology (“SMT”), is omitted, and thus a manufacturing process of the backlight assembly may be simplified.

In addition, since a maximum width of the light emitting unit is defined by a maximum width of the LED package, and the lead frames within the light emitting unit have a thickness smaller than that of the conventional printed circuit board, a size (e.g., thickness, width, weight, etc.) of the backlight assembly and the display apparatus may be reduced.

Further, since a heat transfer member contacts the light emitting unit and the receiving container, heat generated from the light emitting unit may be easily discharged outside the receiving container through the receiving container.

### BRIEF DESCRIPTION OF THE DRAWINGS

The above and other advantages of the invention will become readily apparent by reference to the following detailed description when considered in conjunction with the accompanying drawings wherein:

FIG. 1 is an exploded perspective view showing an exemplary embodiment of a display apparatus including a backlight assembly according, to the invention;

FIG. 2A is a perspective view showing an exemplary embodiment of a coupling state of a receiving container, a light emitting unit and a heat transfer member shown in FIG. 1;

FIG. 2B is a cross-sectional view taken along line I-I′ of FIG. 1;

FIG. 3 is a plan view showing an exemplary embodiment of a light emitting unit shown in FIG. 1;

FIG. 4A is an enlarged view of an exemplary embodiment of a portion of the light emitting unit shown in FIG. 3;

FIG. 4B is an exploded plan view of the light emitting unit shown in FIG. 4A;

FIG. 5 is a cross-sectional view taken along line II-II′ of FIG. 4B; and

FIG. 6 is an enlarged plan view of another exemplary embodiment of a portion of a light emitting unit according to the invention.

### DETAILED DESCRIPTION

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a,” “an” and “the” are intended to include the plural forms as well, unless the context clearly indicates otherwise.

It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be explained in detail with reference to the accompanying drawings.

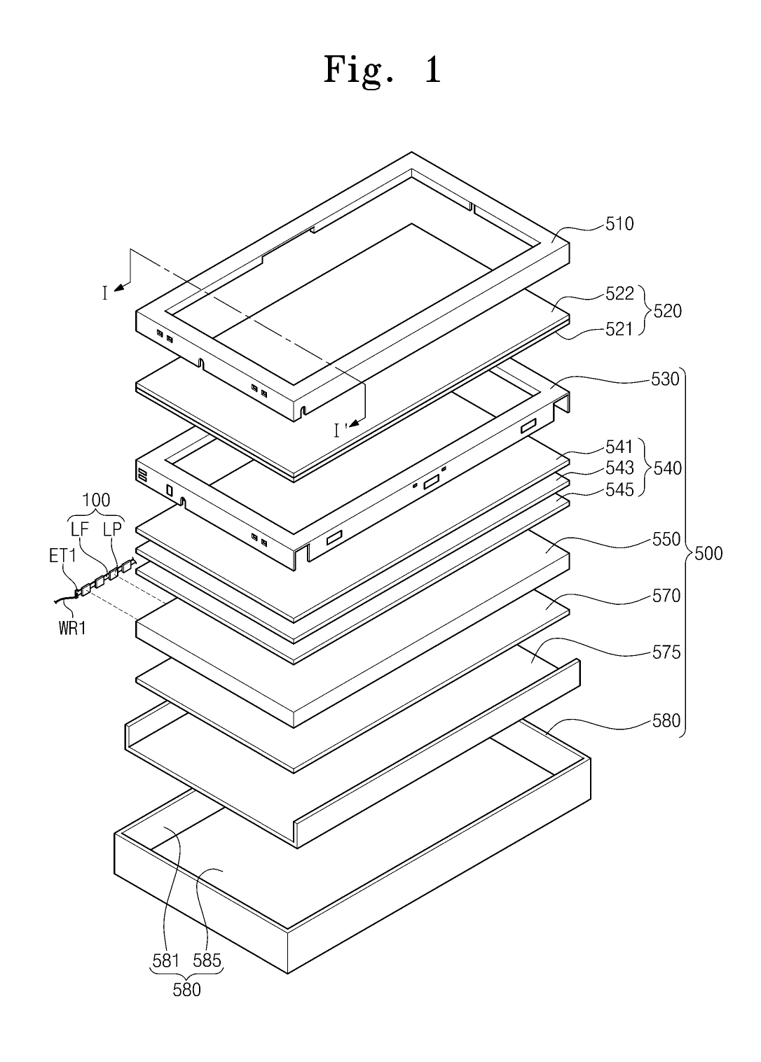

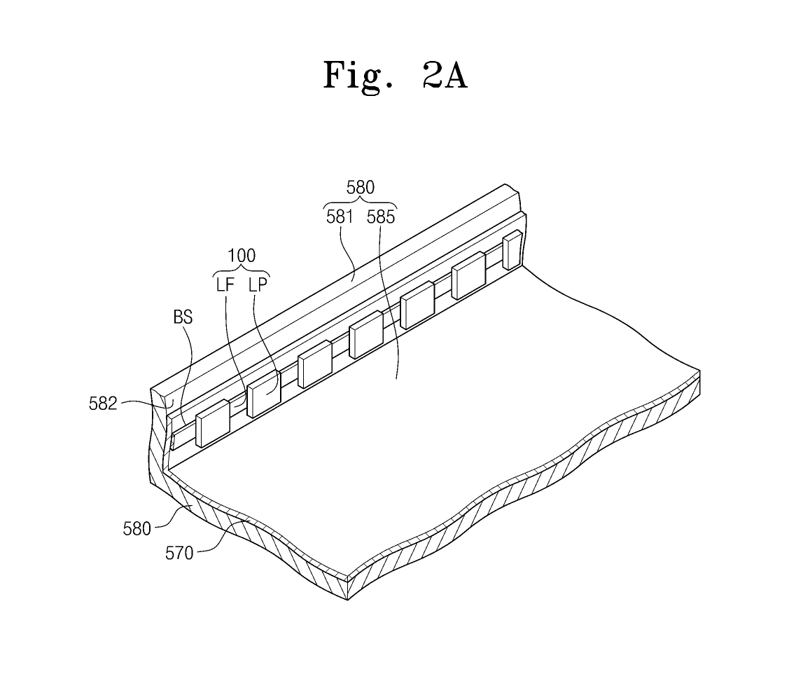

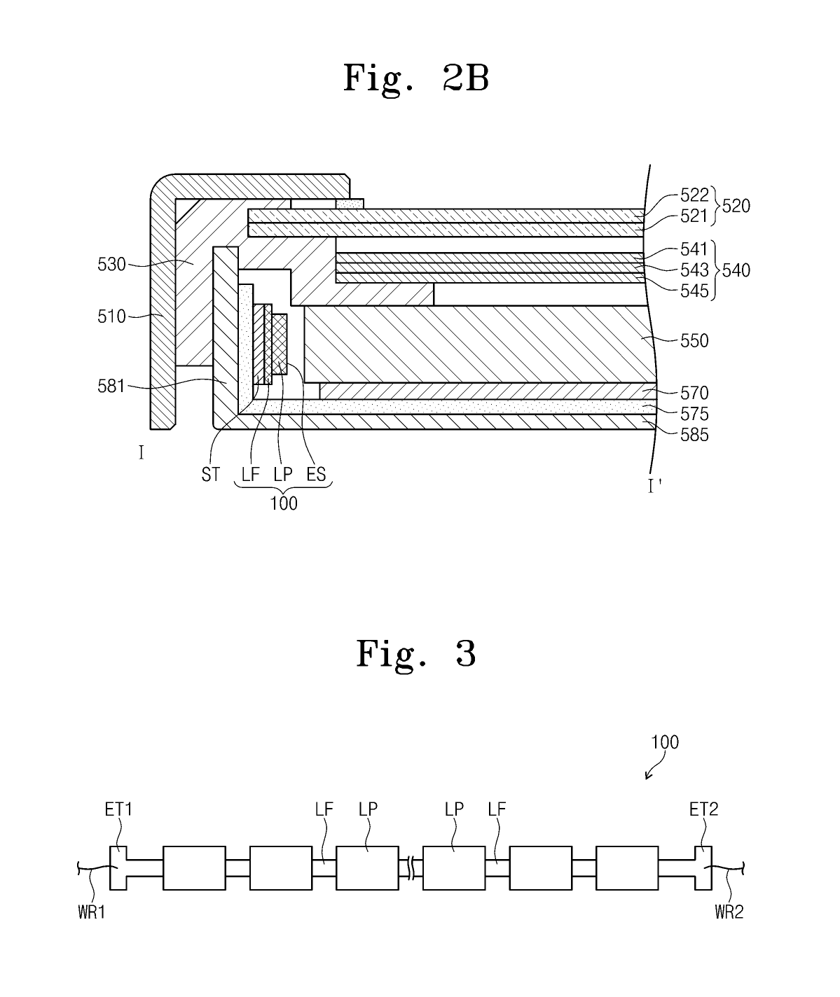

FIG. 1 is an exploded perspective view showing an exemplary embodiment of a display apparatus including a backlight assembly according to the invention, FIG. 2A is a perspective view showing an exemplary embodiment of a coupling state of a receiving container, a light emitting unit and a heat transfer member of FIG. 1, and FIG. 2B is a cross-sectional view taken along line I-I′ of FIG. 1.

Referring to FIGS. 1, 2A, and 2B, a display apparatus includes a backlight assembly 500 and a display panel 520. The backlight assembly 500 generates a light, and the display panel 520 displays an image using the light.

The backlight assembly 500 includes a light emitting unit 100, a receiving container 580, a reflection plate 570, a heat transfer member 575, a light guide plate 550, a plurality of sheets 540, a mold frame 530 and a covering member 510.

The light emitting unit 100 generates the light that is used to display the image on the display panel 520. The light emitting unit 100 includes a light emitting diode (“LED”) package LP and a lead frame LF electrically connected to the LED package LP. The light emitting unit 100 may include a plurality of LED packages LP, and a plurality of lead frames LF electrically connected to the LED packages LP.

The receiving container 580 includes a sidewall 581 and a bottom portion 585. The receiving container 580 may include a plurality of sidewalls 581. In the illustrated exemplary embodiment, the light emitting unit 100 is disposed on an inner lateral surface 582 of a sidewall 581 among a plurality of sidewalls 581 of the receiving container 580, as shown in FIG. 2A. More particularly, a plurality of lead frames LF is coupled to the sidewall 581 such that a bottom surface BS of each of the lead frames LF faces the inner lateral surface 582. The light emitting unit 100 is disposed on the inner lateral surface 582 and elongated along a longitudinal direction of the inner lateral surface 582. A longitudinal axis of the light emitting unit 100 may be substantially parallel to a longitudinal axis of the sidewall 581.

In the illustrated exemplary embodiment, a bonding member ST may be disposed between the sidewall 581 of the receiving container 580 and the lead frames LF of the light emitting unit 100. The lead frames LF are attached to the sidewall 581 by the bonding member ST. The bonding member ST may be a double-sided adhesive tape having an insulating property and a heat conductive property, but is not limited thereto or thereby. In one exemplary embodiment, the double-sided adhesive tape may include an epoxy-containing resin or an acrylic-containing resin as an adhesive material, but is not limited thereto or thereby.

In the illustrated exemplary embodiment, the lead frames LF may include a relatively lightweight metal, such as aluminum, and may have a thin plate shape. Where each of the lead frames LF is a metal plate as described above, the LED packages LP are disposed on an upper surface of the lead frames LF such that the LED packages LP are electrically connected to each other in series. Thus, in the illustrated exemplary embodiment, the LED packages LP are electrically connected to each other in series using the metal plate lead frames LF instead of a conventional printed circuit board that electrically connects the LED packages mounted thereon.

In the illustrated exemplary embodiment, each lead frame LF has a thickness of about 0.2 millimeter (mm) to about 1.0 mm The thickness is taken in a cross-sectional view of the lead frame LF. When the thickness of the lead frame LF is less than 0.2 mm, a rigidity of the lead frame LF decreases and the lead frame LF may be easily deformed or bent. Also, a thickness of the conventional printed circuit board, which is replaced with the lead frames LF, is usually greater than 1.0 mm. Therefore, when the thickness of the lead frame LF is greater than 1.0 mm and similar to the conventional printed circuit board, reducing a size of the backlight assembly 500, which is obtained by replacing the conventional printed circuit board with the lead frames LF, may be negligible or limited.

A plurality of lead frames LF may include a first electrical terminal ET1 disposed at a first end thereof, and a second electrical terminal ET2 (shown in FIG. 3) disposed at a second end opposite to the first end. In the illustrated exemplary embodiment, the first electrical terminal ET1 may be a portion of the lead frame LF disposed at the first end of the plurality of lead frames LF, and the second electrical terminal ET2 may be a portion of the lead frame LF disposed at the second end of the plurality of lead frames LF.

The first electrical terminal ET1 is electrically connected to a first electrode wire WR1, and the second electrical terminal ET2 is electrically connected to a second electrode wire WR2 (shown in FIG. 3). Thus, when the first and second electrode wires WR1 and WR2 are electrically connected to an external power supply unit (not shown), a source voltage is provided to a plurality of LED packages LP through the plurality of lead frames LF, so that the LED packages LP generate the light.

As described above, the light emitting unit 100 is coupled to the sidewall 581 among the plurality of sidewalls 581 of the receiving container 580. According to another exemplary embodiment, however, the light emitting unit 100 may be provided in plural. Where the light emitting unit 100 is provided in plural, more than one light emitting unit 100 may be disposed on the inner lateral surface 582 of the same sidewall 581, or the plural light emitting units 100 are disposed on inner lateral surfaces of more than one (e.g., different) sidewalls 581 of the receiving container 580.

The receiving container 580 includes the bottom portion 585, and the sidewalls 581 are extended from a side or edge of the bottom portion 585. The sidewalls 581 and the bottom portion 585 accommodate elements of the backlight assembly 500 therein. In the exemplary embodiment, the receiving container 580 may include a metal material in order to easily discharge heat, which is generated from the light emitting unit 100, to outside the receiving container 580, but is not limited thereto or thereby. In addition, as described above, the light emitting unit 100 is disposed on the inner lateral surface 582 of the sidewall 581 among the plurality of sidewalls 581.

The heat transfer member 575 is disposed between the sidewall 581 of the receiving container 580 and the lead frames LF of the light emitting unit 100. The heat transfer member 575 contacts the lead frames LF and the receiving container 580. The heat transfer member 575 may be a single, unitary, indivisible unit, but is not limited thereto or thereby. Therefore, the heat transfer member 575 transfers the heat generated from the light emitting unit 100 to the receiving container 580, and the heat transferred to the receiving container 580 is easily discharged to the outside of the receiving container 580.

In the illustrated exemplary embodiment, portions of the heat transfer member 575 may be disposed on a first sidewall 581, a second sidewall facing the first sidewall 581, and the bottom portion 585. Also, the heat transfer member 575 may include, but is not limited to, graphite which has excellent heat conductivity, e.g., e-GRAF® made by GrafTech International. Where the heat transfer member 575 has a thickness of about 0.5 mm, heat conductivity thereof is similar to that of an aluminum plate having a thickness of about 1.2 mm Therefore, when the backlight assembly 500 includes the heat transfer member 575 having a thickness of about 0.5 mm, a size of the backlight assembly 500 is easily reduced since the heat transfer member 575 is used to transfer the heat generated from the light emitting unit 100 to the receiving container 580.

The light guide plate 550 is accommodated in the receiving container 580, and includes a side portion which faces the light emitting unit 100. The LED package LP includes a light emitting surface ES through which light is emitted. Thus, the light emitted from the light emitting surfaces ES of the LED packages LP in the light emitting unit 100 is incident to the light guide plate 550 through the side portion of the light guide plate 550. The light incident to the light guide plate 550 exits from the light guide plate 550 through a light emitting surface facing the display panel 520 and travels to the display panel 520. The light emitting surface of the light guide plate 550 may include a light guide pattern (not shown).

The reflection plate 570 includes a material that reflects the light, such as polyethylene terephthalate (“PET”), aluminum, etc., and is disposed between the bottom portion 585 of the receiving container 580 and the light guide plate 550. Thus, the light, which is generated by the light emitting unit 100 and not incident to the light guide plate 550, is reflected by the reflection plate 570 and incident to the light guide plate 550.

The mold frame 530 is coupled to the receiving container 580 to fix an edge of the light guide plate 550 to the bottom portion 585 of the receiving container 580. One or more portions of the mold frame 530 is substantially parallel to the bottom portion 585, and a portion of the mold frame 530 is substantially parallel to the sidewall 581 of the receiving container 580. The sheets 540 and the display panel 520 are seated on the mold frame 530.

The sheets 540 are disposed below the display panel 520. The sheets 540 include optical sheets to control a path of the light exiting from the light guide plate 550 and incident to the display panel 520, and a protection sheet to protect a surface of the display panel 520. In the illustrated exemplary embodiment, the sheets 540 include a protection sheet 541 protecting a rear surface of the display panel 520, a prism sheet 543 improving brightness at a viewing side of the display apparatus, and a diffusion sheet 545 diffusing the light from the light guide plate 550.

The display panel 520 receives the light generated by the backlight assembly 500 and displays the image. The display panel 520 may be, but is not limited to, a liquid crystal display panel. As a liquid crystal display panel, the display panel 520 includes a first substrate 521 including a plurality of pixel electrodes, a second substrate 522 facing the first substrate 521 and including a common electrode, and a liquid crystal layer (not shown) interposed between the first substrate 521 and the second substrate 522.

According to another exemplary embodiment, the display panel 520 may be, but is not limited to, an electrowetting display panel. As an electrowetting display panel, the display panel 520 includes a fluid layer (not shown) disposed between the first substrate 521 and the second substrate 522 instead of the liquid crystal layer. The fluid layer includes two fluids, which are not mixed with and remain separated from each other, and one of the two fluids has an electrical polarity.

The covering member 510 is partially opened to expose a display area of the display panel 520, and is coupled to the receiving container 580 to cover (e.g., overlap) an edge of the display panel 520. Accordingly, the elements of the backlight assembly 500 are stably accommodated in the receiving container 580 via the coupling of the covering member 510 to the receiving container 580.

FIG. 3 is a plan view showing an exemplary embodiment of a light emitting unit of FIG. 1.

Referring to FIG. 3, the light emitting unit 100 includes the plurality of LED packages LP, the plurality of lead frames LF, the first electrode wire WR1 and the second electrode wire WR2.

The plurality of lead frames LF has a longitudinal axis which extends in one direction, and the plurality of LED packages LP are disposed on the upper surfaces of the plurality of lead frames LF. The plurality of LED packages LP are spaced apart from each other along the one direction and electrically connected to the plurality of lead frames LF, respectively.

The first electrode wire WR1 is electrically connected to the first electrical terminal ET1 corresponding to a portion of the lead frame LF disposed at the first end of the plurality of lead frames LF, and the second electrode wire WR2 is electrically connected to the second electrical terminal ET2 corresponding to a portion of the lead frame LF disposed at the second end of the plurality of lead frames LF. Thus, when the first electrode wire WR1 is connected to one electrode of two electrodes in the power supply unit (not shown) and the second electrode wire WR2 is connected to the other electrode of the two electrodes in the power supply unit, the plurality of LED packages LP may emit the light in response to the source voltage generated and provided from the power supply unit.

In the illustrated exemplary embodiment shown in FIG. 3, the plurality of LED packages LP are arranged in the one direction. However, in an alternative exemplary embodiment, the plurality of LED packages LP may be arranged in a matrix configuration of columns by rows. Where the plurality of LED packages LP are arranged in the matrix configuration, additional lead frames LF may be further required to electrically connect the plurality of LED packages arranged in rows by columns.

Hereinafter, a structure of the lead frames LF and the LED packages LP will be described in detail.

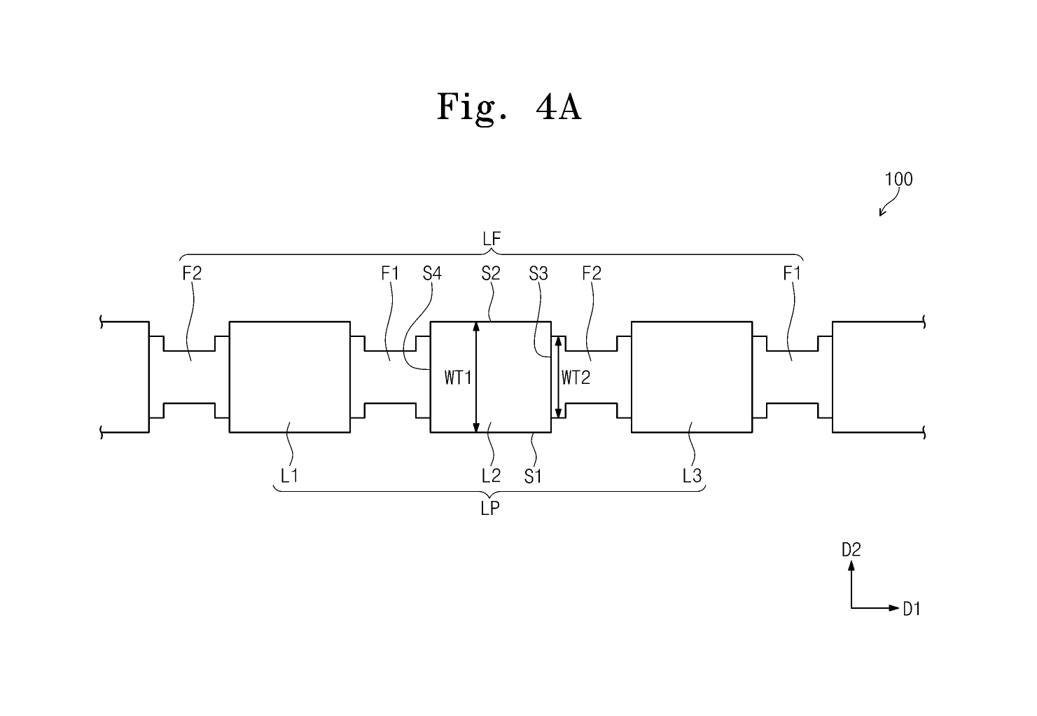

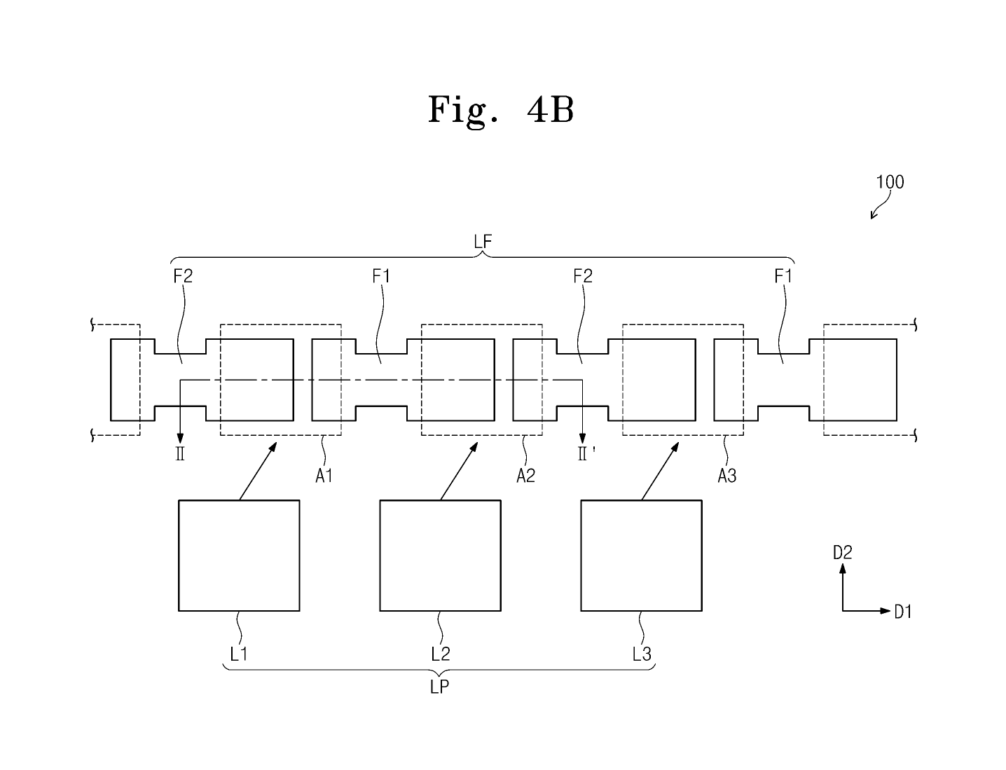

FIG. 4A is an enlarged view showing an exemplary embodiment of a portion of the light emitting unit of FIG. 3, and FIG. 4B is an exploded plan view showing the light emitting unit of FIG. 4A.

Referring to FIGS. 4A and 4B, the light emitting unit 100 includes the plurality of lead frames LF and the plurality of LED packages LP. The plurality of lead frames LF includes a plurality of first lead frames F1 and a plurality of second lead frames F2. In FIGS. 4A and 4B, for the convenience of explanation, two first lead frames F1 among the plurality of first lead frames F1, and two second lead frames F2 among the plurality of second lead frames F2 are illustrated as representative examples and the others are omitted. In addition, in FIGS. 4A and 4B, a first LED package L1, a second LED package L2 and a third LED package L3 among the plurality of LED packages LP are illustrated as representative examples, and the others are omitted.

The two first lead frames F1 are alternately arranged with the two second lead frames F2 along the one direction. In one exemplary embodiment, for instance, as shown in FIGS. 4A and 4B, a second lead frame F2, a first lead frame F1, a second lead frame F2, and a first lead frame F1 are sequentially arranged in a first direction D1.

In addition, when assuming that a first lead frame F1 and a second lead frame F2 are alternately arranged with each other in each of first, second and third areas A1, A2 and A3, the first, second and third LED packages L1, L2 and L3 are arranged to correspond to the first, second and third areas A1, A2 and A3 in a one-to-one correspondence relationship. Therefore, each of the first, second and third LED packages L1, L2 and L3 may be arranged on both an upper portion of the first lead frame F1 and an upper portion of the second lead frame F2 adjacent to the first lead frame F1 in the respective areas.

When each of the first, second and third LED packages L1, L2 and L3 has a first width WT1 taken in a second direction D2 and each of the first and second lead frames F1 and F2 has a second width WT2 taken in the second direction D2 when viewed in a plan view, a maximum value of the first width WT1 is larger than a maximum value of the second width WT2.

In addition, each of the first, second and third LED packages L1, L2 and L3 is defined by a first side S1 and a second side S2 which are substantially parallel to the first direction D1, and a third side S3 and a fourth side S4 which are substantially parallel to the second direction D2 substantially perpendicular to the first direction D1 in the plan view. Referring to FIGS. 4A and 4B, the first and second lead frames F1 and F2 are overlapped with the third side S3 and the fourth side S4, and not overlapped with the first side S1 and the second side S2 among the first, second, third and fourth sides S1, S2, S3 and S4 of the plurality of LED packages LP.

According to the arrangement relationship of the first, second and third LED packages L1, L2 and L3 and the first and second lead frames F1 and F2, a maximum overall width of the light emitting unit 100 is the same as and defined by the first width WT1 of a respective LED package LP. In other words, the overall width of the light emitting unit 100 may be decreased to the first width WT1, and the overall width of the light emitting unit 100 does not increase due to the first and second lead frames F1 and F2.

Where the first, second and third LED packages L1, L2 and L3 are mounted on a conventional printed circuit board instead of one or more exemplary embodiment of the first and second lead frames F1 and F2, the overall width of the light emitting unit 100 increases due to a width of the printed circuit board since the width of the printed circuit board is larger than the second width WT2 of the lead frame LF. As described with respect to one or more exemplary embodiment, however, when the lead frames LF are used instead of the conventional printed circuit board, the lead frames LF may be designed such that the second width WT2 of the lead frames LF becomes smaller than the first width WT1 of the LED packages LP since the lead frames LF of the invention have a relatively simplified structure when compared to the conventional printed circuit board. In addition, the overall width of the light emitting unit 100 may decrease to correspond to the width of each of the first, second and third LED packages L1, L2 and L3.

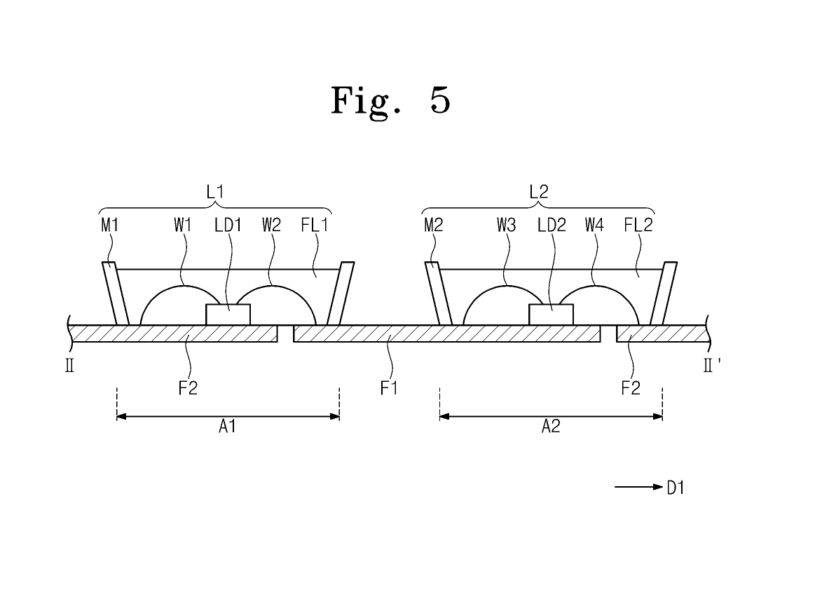

FIG. 5 is a cross-sectional view taken along line II-II′ of FIG. 4B. Referring to FIG. 5, a (first) second lead frame F2, a first lead frame F1, and a (second) second lead frame F2 are sequentially arranged in the first direction D1. The first LED package L1 is disposed on the upper portions of the (first) second lead frame F2 and the first lead frame F1 to correspond to the first area A1. The second LED package L2 is disposed on the upper portions of the (second) second lead frame F2 and the first lead frame F1 to correspond to the second area A2.

The first LED package L1 includes a first mold M1, a first light emitting diode LD1, a first lead wire W1, a second lead wire W2 and a first protection layer FL1. The first light emitting diode LD1 is accommodated in the first mold M1 and disposed on the (first) second lead frame F2.

The first protection layer FL1 is accommodated in the first mold M1 to cover the first light emitting diode LD1, the first lead wire W1 and the second lead wire W2. In the illustrated exemplary embodiment, the first protection layer FL1 may include an insulating material having excellent light transmissivity, such as, silicon resin, epoxy resin, etc. The first protection layer FL1 may include a fluorescent substance or quantum dot to change a wavelength of the light generated from the first light emitting diode LD1.

The first lead wire W1 electrically connects a positive electrode (not shown) of the first light emitting diode LD1 to the (first) second lead frame F2 located at a left side of the first lead frame F1. The second lead wire W2 electrically connects a negative electrode (not shown) of the first light emitting diode LD1 to the first lead frame F1.

The second LED package L2 includes a second mold M2, a second light emitting diode LD2, a third lead wire W3, a fourth lead wire W4 and a second protection layer FL2. The second light emitting diode LD2 is accommodated in the second mold M2 and disposed on the first lead frame F1. The second protection layer FL2 may include an insulating material having excellent light transmissivity, such as, silicon resin, epoxy resin, etc. The second protection layer FL2 is accommodated in the second mold M2 to cover the second light emitting diode LD2, the third lead wire W3 and the fourth lead wire W4.

In addition, the third lead wire W3 electrically connects a positive electrode (not shown) of the second light emitting diode LD2 to the first lead frame F1, and the fourth lead wire W4 electrically connects a negative electrode (not shown) of the second light emitting diode LD2 to the (second) second lead frame F2 located at a right side of the first lead frame F1.

Therefore, the first and second light emitting diodes LD1 and LD2 are electrically connected in series to the (first) second lead frame F2, the first lead frame F1 and the (second) second lead frame F2, which are sequentially arranged in the first direction D1, via the first, second, third and fourth lead wires W1, W2, W3 and W4, respectively.

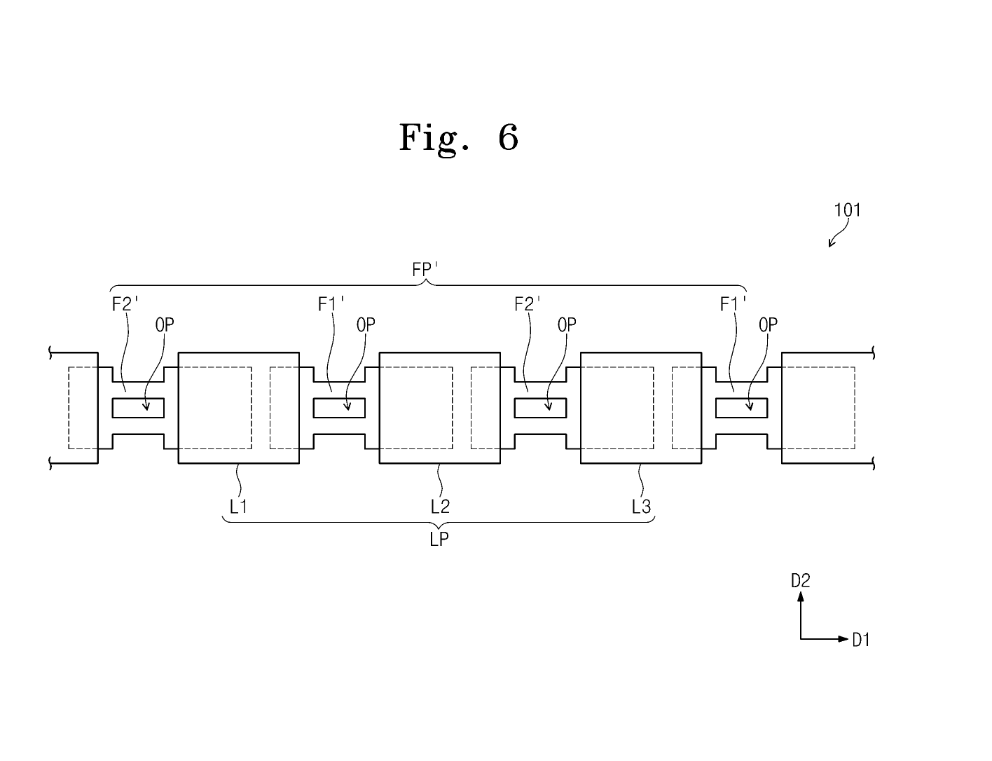

FIG. 6 is an enlarged view showing another exemplary embodiment of a portion of a light emitting unit according to the invention. In FIG. 6, the same reference numerals denote the same elements in FIGS. 1 to 5, and thus detailed descriptions of the same elements will be omitted.

Referring to FIG. 6, the light emitting unit 101 includes a plurality of lead frames FP′, and the plurality of lead frames LF′ include a plurality of first lead frames F1′ and a plurality of second lead frames F2′. The plurality of lead frames FP′ are provided with openings OP extended partially or completely through thicknesses thereof In the illustrated exemplary embodiment, each of the plurality of lead frames FP′ includes an opening OP extended through a thickness thereof, but is not limited thereto or thereby. The openings OP are exposed by the plurality of light emitting packages LP, and do not overlap the plurality of light emitting packages LP.

At the opening OP, a portion of a material of the respective lead frame FP is omitted or missing. Thus, a total weight of the plurality of lead frames FP′ within the light emitting unit 101 is reduced by the openings OP, so that an overall weight of a backlight assembly 500 (shown in FIG. 1) including the plurality of lead frames FP′, and an overall weight of a display apparatus having the backlight assembly 500, are reduced.

In addition, since each of the openings OP has a closed shape when viewed in a plan view, a decrease in rigidity of the lead frames FP′ due to the openings OP may be minimized.

In FIG. 6, each of the openings OP has a square shape in a plan view, but the openings OP should not be limited to the square shape. That is, for example, each of the openings OP may have a polygonal shape or a circular shape.

Although exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A backlight assembly comprising:
a receiving container comprising a bottom portion, and a sidewall extended from the bottom portion;
a light emitting unit on an inner lateral surface of the sidewall; and
a light guide plate in the receiving container, and comprising a side surface facing the light emitting unit,
wherein the light emitting unit comprises:
a light emitting diode package which generates a light;
a first lead frame electrically connected to a first electrode of the light emitting diode package; and
a second lead frame spaced apart from the first lead frame, and electrically connected to a second electrode of the light emitting diode package.

2. The backlight assembly of claim 1, wherein a bottom surface of each of the first and second lead frames of the light emitting unit faces the inner lateral surface of the sidewall of the receiving container.

3. The backlight assembly of claim 2, wherein the light emitting diode package is on an upper surface of the first lead frame and the second lead frame.

4. The backlight assembly of claim 3, wherein a width of each of the first and second lead frames is smaller than a width of the light emitting diode package, taken in a same direction.

5. The backlight assembly of claim 4, wherein
the first lead frame, the light emitting diode package and the second lead frame are sequential in a first direction in a plan view,
the light emitting diode package comprises a plurality of sides defining the light emitting diode package, and two sides are substantially parallel to a second direction different from the first direction, and
the first and second lead frames overlap the two sides of light emitting diode package.

6. The backlight assembly of claim 4, wherein a maximum width of the light emitting unit is substantially equal to the width of the light emitting diode package.

7. The backlight assembly of claim 4, further comprising a plurality of light emitting diode packages, a plurality of first lead frames and a plurality of second lead frames,
wherein
the plurality of first lead frames alternate with the plurality of second lead frames in a first direction, and
the plurality of light emitting diode packages are in one-to-one correspondence with areas between adjacent first and second lead frames, respectively.

8. The backlight assembly of claim 2, further comprising a bonding member between each of the first and second lead frames, and the inner lateral surface of the sidewall of the receiving container, respectively,
wherein the bonding member comprises an insulating and heat conducting material, and attaches the first and second lead frames to the inner lateral surface.

9. The backlight assembly of claim 1, wherein the light emitting unit further comprises:
a first electrode wire which electrically connects the first electrode of the light emitting package to the first lead frame; and
a second electrode wire which electrically connects the second electrode of the light emitting package to the second lead frame.

10. The backlight assembly of claim 1, further comprising a heat transfer member between the first lead frame and the inner lateral surface, and between the second lead frame and the inner lateral surface,
wherein the heat transfer member comprises graphite, and transfers heat from the first and second lead frames to the receiving container.

11. The backlight assembly of claim 10, wherein the heat transfer member contacts the inner lateral surface and the bottom portion of the receiving container.

12. The backlight assembly of claim 1, wherein the first lead frame or the second lead frame comprises an opening.

13. The backlight assembly of claim 1, wherein a thickness of each of the first lead frame and the second lead frame is about 0.2 millimeter to about 1.0 millimeter.

14. A display apparatus comprising:
a display panel which displays an image using a light; and
a backlight assembly providing the light to the display panel, the backlight assembly comprising:
a receiving container comprising a bottom portion, and a sidewall extended from the bottom portion;
a light emitting unit on an inner lateral surface of the sidewall, wherein the light emitting unit generates the light; and
a light guide plate which receives the light from the light emitting unit and guides the light to the display panel, wherein the light guide plate is in the receiving container and comprises a side surface facing the light emitting unit,
wherein the light emitting unit comprises:
a light emitting diode package which generates the light;
a first lead frame electrically connected to a first electrode of the light emitting diode package; and
a second lead frame spaced apart from the first lead frame and electrically connected to a second electrode of the light emitting diode package.

15. The display apparatus of claim 14, wherein a bottom surface of each of the first and second lead frames of the light emitting unit faces the inner lateral surface of the sidewall of the receiving container.

16. The display apparatus of claim 15, wherein the light emitting diode package is on an upper surface of the first lead frame and the second lead frame.

17. The display apparatus of claim 16, wherein
a width of each of the first and second lead frames is smaller than a width of the light emitting diode package taken in a same direction, in a plan view, and
a maximum width of the light emitting unit is substantially equal to the width of the light emitting diode package in the plan view.

18. The display apparatus of claim 17, wherein
the first lead frame, the light emitting diode package and the second lead frame are sequential in a first direction in the plan view,
the light emitting diode package comprises a plurality of sides defining the light emitting diode package, and two sides are substantially parallel to a second direction different from the first direction, and
the first and second lead frames overlap the two sides of the light emitting diode package.

19. The display apparatus of claim 16, further comprising a plurality of light emitting diode packages, a plurality of first lead frames and a plurality of second lead frames,
wherein
the plurality of first lead frames alternate with the plurality of second lead frames in a first direction, and
the plurality of light emitting diode packages are in one-to-one correspondence with areas between adjacent first and second lead frames, respectively.

20. The display apparatus of claim 15, further comprising:
a bonding member between each of the first and second lead frames, and the inner lateral surface of the sidewall of the receiving container, respectively,
wherein the bonding member comprises an insulating and heat conducting material, and attaches the first and second lead frames to the inner lateral surface; and
a heat transfer member between the first lead frame and the inner lateral surface, and between the second lead frame and the inner lateral surface,
wherein the heat transfer member comprises graphite, transfers heat from the first and second lead frames to the receiving container, and contacts the inner lateral surface and the bottom portion of the receiving container.
